(19) United States
(12) Patent Application Publication
(10) Pub. No.: US 2026/0211999 A1
(43) Pub. Date: Jul. 23, 2026

(54) MULTI-TENANT ORGANIZATIONAL HIERARCHY AND ASSET MANAGEMENT PLATFORM

(71) Applicant: FAIR ISAAC CORPORATION, Minneapolis, MN (US)

(72) Inventors: Prashant Jamkhedkar, Fremont, CA (US); Jeffrey B. Smith, Newmarket (CA); Christopher Schultz, Eagan, MN (US); Karissa Kay Kohn, North Saint Paul, MN (US); Paul David Daro, Mill Valley, CA (US)

(21) Appl. No.: 19/033,136

(22) Filed: Jan. 21, 2025

(51) Int. Cl. G06F 21/53; G06F 21/62

(52) U.S. Cl. CPC G06F 21/53; G06F 21/6218

(57) ABSTRACT

A method for managing a multi-tenant platform, comprising: enabling access from a plurality of tenants to the platform through a multi-tenant architecture supporting organizational units and segmentation units; generating a tenant-specific execution context upon receiving a request from a tenant to access the platform via recalling the organizational unit associated with the tenant; defining asset sharing rules for tenants based on declarative protocols, wherein the asset sharing rules allow selective and controlled access to shared assets between tenants, and wherein the declarative protocols are configuration-based rules that specify conditions for asset access and sharing; dynamically configuring platform services to operate in a shared multi-tenant mode or an isolated single-tenant mode, according to tenant-specific requirements for data isolation in the execution context; and implementing policies across the organizational units and the segmentation units to provide granular control over access permissions, resource utilization, and data sharing rules among tenants.

### TECHNICAL FIELD

The subject matter described herein relates to multi-tenant platform technology, specifically systems and methods for secure and flexible organizational hierarchy management, asset sharing, and tenant isolation across various business environments.

### BACKGROUND

In numerous industries, such as technology, finance, and e-commerce, efficiently managing multiple tenants on a single platform is essential for optimizing resource usage, ensuring data privacy, and providing customized services. Organizations often need to share assets, maintain isolated environments for each tenant, and allow varying levels of access while preserving security. Traditional multi-tenant platforms tend to use rigid structures and single-tenant setups, which can be inefficient, especially in dynamic business environments where rapid adjustments in asset sharing, data isolation, and access control are necessary. This lack of flexibility can lead to increased operational costs, security vulnerabilities, and limited customization, ultimately hindering the ability to scale and adapt to client needs.

Current multi-tenant models are frequently limited in their ability to balance efficient resource sharing with tenant isolation. These models typically rely on predefined access policies and static configurations, which do not accommodate dynamic, tenant-specific needs for data management or asset sharing. Additionally, static tenant structures often lack the ability to customize operational permissions and manage assets dynamically, making it difficult to implement flexible, secure tenancy configurations across different organizational levels and roles. As a result, traditional systems may fall short of providing the adaptability and control required in complex, multi-tenant scenarios.

There is a need for advanced multi-tenant platforms capable of supporting secure asset sharing, flexible hierarchical arrangement, and modular access control to address the challenges of evolving business demands. Such a platform would allow organizations to efficiently manage resources, enable tenant-specific configurations, and support various levels of tenancy while ensuring data security and compliance. This solution would empower organizations across industries to optimize tenant operations, improve customization, and foster more scalable and adaptable business solutions.

### SUMMARY

Methods, systems, and articles of manufacture, including computer program products, are provided for a method for managing a multi-tenant platform, including enabling access from a plurality of tenants to the platform through a multi-tenant architecture supporting organizational units and segmentation units, wherein each of the plurality of tenants is associated with an organization unit and one or more segmentation unit; generating a tenant-specific execution context upon receiving a request from a tenant to access the platform via recalling the organizational unit associated with the tenant, wherein the execution context includes metadata configured to maintain tenant isolation and propagate tenant-specific configuration and access controls on the platform for the tenant; defining asset sharing rules for tenants based on declarative protocols, wherein the asset sharing rules allow selective and controlled access to shared assets between tenants, and wherein the declarative protocols are configuration-based rules that specify conditions for asset access and sharing; dynamically configuring platform services to operate in a shared multi-tenant mode or an isolated single-tenant mode, according to tenant-specific requirements for data isolation in the execution context; and implementing policies across the organizational units and the segmentation units to provide granular control over access permissions, resource utilization, and data sharing rules among tenants.

In some variations, the policies are cascading policies where policies associated with an organization unit for a particular tenant apply to the one or more segmentation units of the particular tenant.

In some variations, the policies are overridable at the one or more segmentation units.

In some variations, each of the plurality of tenants comprises one or more users, the method further comprises assigning the one or more users to user groups, wherein each user group is associated with permissions that are scoped to designated assets, segmentation units, and applicable policies.

In some variations, the execution context comprises a tenant identifier and user group information associated with the tenant.

In some variations, the execution context provides a tenant-specific runtime environment to isolate operations and enforce policies when a tenant accesses the platform.

In some variations, the method further includes monitoring and logging a plurality of actions performed within the execution context, wherein each action of the plurality of actions is attributed to a specific user group and segmentation unit of the tenant to provide traceability.

In another aspect, there is provided a computer program product for managing a multi-tenant platform. The computer program product includes a non-transitory computer readable medium storing instructions that, when executed by at least one programmable processor, cause the at least one programmable processor to perform operations. The operations include enabling access from a plurality of tenants to the platform through a multi-tenant architecture supporting organizational units and segmentation units, wherein each of the plurality of tenants is associated with an organization unit and one or more segmentation unit; generating a tenant-specific execution context upon receiving a request from a tenant to access the platform via recalling the organizational unit associated with the tenant, wherein the execution context includes metadata configured to maintain tenant isolation and propagate tenant-specific configuration and access controls on the platform for the tenant; defining asset sharing rules for tenants based on declarative protocols, wherein the asset sharing rules allow selective and controlled access to shared assets between tenants, and wherein the declarative protocols are configuration-based rules that specify conditions for asset access and sharing; dynamically configuring platform services to operate in a shared multi-tenant mode or an isolated single-tenant mode, according to tenant-specific requirements for data isolation in the execution context; and implementing policies across the organizational units and the segmentation units to provide granular control over access permissions, resource utilization, and data sharing rules among tenants.

In some variations, the policies are cascading policies where policies associated with an organization unit for a particular tenant apply to the one or more segmentation units of the particular tenant.

In some variations, the policies are overridable at the one or more segmentation units.

In some variations, each of the plurality of tenants comprises one or more users, the method further comprises assigning the one or more users to user groups, wherein each user group is associated with permissions that are scoped to designated assets, segmentation units, and applicable policies.

In some variations, the execution context comprises a tenant identifier and user group information associated with the tenant.

In some variations, the execution context provides a tenant-specific runtime environment to isolate operations and enforce policies when a tenant accesses the platform.

In some variations, the method further includes monitoring and logging a plurality of actions performed within the execution context, wherein each action of the plurality of actions is attributed to a specific user group and segmentation unit of the tenant to provide traceability.

In another aspect, there is provided a system for managing a multi-tenant platform. The system includes: a programmable processor; and a non-transient machine-readable medium storing instructions that, when executed by the processor, cause the at least one programmable processor to perform operations. The operations include enabling access from a plurality of tenants to the platform through a multi-tenant architecture supporting organizational units and segmentation units, wherein each of the plurality of tenants is associated with an organization unit and one or more segmentation unit; generating a tenant-specific execution context upon receiving a request from a tenant to access the platform via recalling the organizational unit associated with the tenant, wherein the execution context includes metadata configured to maintain tenant isolation and propagate tenant-specific configuration and access controls on the platform for the tenant; defining asset sharing rules for tenants based on declarative protocols, wherein the asset sharing rules allow selective and controlled access to shared assets between tenants, and wherein the declarative protocols are configuration-based rules that specify conditions for asset access and sharing; dynamically configuring platform services to operate in a shared multi-tenant mode or an isolated single-tenant mode, according to tenant-specific requirements for data isolation in the execution context; and implementing policies across the organizational units and the segmentation units to provide granular control over access permissions, resource utilization, and data sharing rules among tenants.

In some variations, the policies are cascading policies where policies associated with an organization unit for a particular tenant apply to the one or more segmentation units of the particular tenant.

In some variations, the policies are overridable at the one or more segmentation units.

In some variations, each of the plurality of tenants comprises one or more users, the method further comprises assigning the one or more users to user groups, wherein each user group is associated with permissions that are scoped to designated assets, segmentation units, and applicable policies.

In some variations, the execution context comprises a tenant identifier and user group information associated with the tenant.

In some variations, the execution context provides a tenant-specific runtime environment to isolate operations and enforce policies when a tenant accesses the platform.

In some variations, the method further includes monitoring and logging a plurality of actions performed within the execution context, wherein each action of the plurality of actions is attributed to a specific user group and segmentation unit of the tenant to provide traceability.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a multi-tenant platform comprising components designed to support hierarchical segmentation, asset sharing, and tenant isolation, in accordance with one or more embodiments of the current subject matter.

FIG. 2 is a diagram illustrating an example of the asset sharing model by the multi-tenant platform, in accordance with one or more embodiments.

FIG. 3 is a diagram illustrating an example of the user group tenancy model 300 to illustrate asset control flow within the multi-tenant platform, in accordance with one or more embodiments

FIG. 4 is a diagram illustrating a flow chart of a process for managing a multi-tenant platform, in accordance with one or more embodiments of the current subject matter.

FIG. 5 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

The present disclosure relates to a modular and composable platform architecture configured to facilitate integration across a plurality of business capabilities, including decisioning, analytics, optimization, and data management. This architecture is enabled by declarative protocols and flexible asset management. In some embodiments, the declarative protocols are those that set standardized rules for how assets interact within the platform, specifying interaction semantics, versioning, and compliance parameters to ensure seamless integration. Explain its role in creating modularity by allowing different asset types to work within shared protocols, enhancing consistency. The platform incorporates standardized protocol semantics, modular components, and multi-tenant management strategies to address complex business requirements, providing enhanced scalability and operability. Monolithic architectures typically experience significant strain on system resources due to tightly coupled dependencies, which can cause loading and response delays. In such systems, even minor updates can lead to cascading effects across multiple modules, creating bottlenecks and increasing deployment complexity. In some embodiments, the composable platform capability provides a foundational architecture for implementing declarative cross-cutting asset semantics to achieve flexible composition and standardized management of assets. This may include defining standardized interactions between assets, thereby enabling seamless integration of assets within the platform. The capability further includes a repository structure for asset storage and versioning, supporting multiple protocol versions to maintain compatibility between various iterations, thereby improving adaptability and scalability. The architecture may also facilitate flexible deployment of business function modules, enabling efficient management processes while maintaining high scalability. In some embodiments, the composable micro frontends capability implements a modular frontend architecture for the platform, utilizing micro frontends to build user interfaces. This capability may leverage declarative protocols and module federation to enable dynamic loading and composition of frontend components. The micro frontends capability further supports the loading and embedding of user interface components without necessitating a complete recompilation of the application, thus allowing for flexible customization and expansion of user interfaces. This architecture may enhance user experience by enabling the adjustment of frontend interactions according to specific requirements. In some embodiments, the multi-tenant capability provides strategies for managing multi-tenant environments and organizational hierarchies, allowing for secure and flexible asset management in multi-user settings. This capability may include defining hierarchical organizational structures that manage asset sharing and data isolation between tenants. It may further support tenant isolation to ensure the separation of data and business logic across different tenants, thus meeting data privacy and compliance requirements. Additionally, this capability may include configurable policies that support the customization of platform functionalities and access rights based on specific tenant requirements, facilitating adaptable and secure asset management in complex multi-tenant environments.

In some embodiments, declarative protocols establish standardized rules that automate and maintain interaction semantics across varying asset types within the platform. These protocols define interaction semantics to guide asset interactions through specific rules and configurations that support both consistency and adaptability. By abstracting the technical configurations necessary for asset integration, declarative protocols allow assets to interact seamlessly and autonomously without requiring significant manual configuration. This abstraction enables assets to adapt dynamically to new operational requirements while adhering to pre-established interaction conventions, thus promoting continuity as assets evolve over time. As new assets or functionality updates are introduced, declarative protocols provide a cohesive framework that aligns asset behavior with platform-wide standards, reducing the need for custom adjustments while maintaining operational integrity across the platform. Declarative protocols not only establish foundational rules for micro front end interoperability but also support dynamic updates and synchronization across components. For example, declarative protocols enable the platform to seamlessly adjust and propagate version changes without requiring manual reconfiguration, thus preserving the stability and continuity of user interfaces as components evolve.

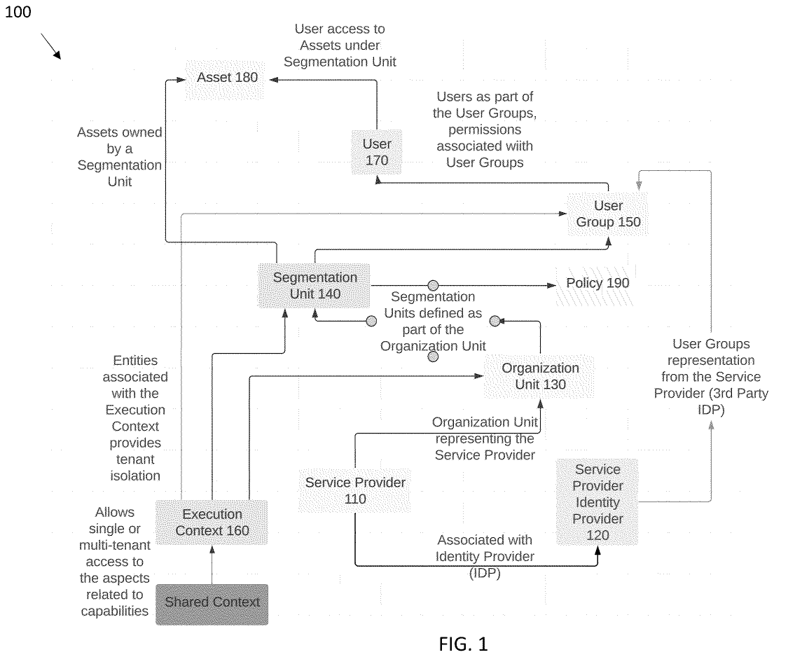

FIG. 1 illustrates a multi-tenant platform 100 comprising components designed to support hierarchical segmentation, asset sharing, and tenant isolation. A tenant is an independent client entity using the platform, such as a company or organization that maintains its own data, resources, and users while sharing infrastructure with other tenants. In this example, each tenant, such as a service provider 110, has specific access control needs and may include multiple organizational structures.

As shown in FIG. 1, the platform 100 includes a service provider 110, which may define specialized access policies, allowing management of organizations with distinct control levels. In some embodiments, the service provider 110 may include multiple tiers of control for its organizations, for example, allowing a service provider (e.g., the service provider 110 as shown in FIG. 1) to set global policies while enabling each organization to apply specific policies at the organization or segmentation unit level. The service provider identity provider 120 may manage users and user groups associated with service provider, enforcing access permissions based on predefined rules and ensuring that each organization's user groups are appropriately segmented and isolated within the platform. In some embodiments, the service provider identity provider 120 may offer advanced authentication and authorization mechanisms for managing organizations, for example, implementing multi-factor authentication (MFA) for user access, role-based access control (RBAC) to define user group permissions, or integration with external identity providers to streamline user provisioning and de-provisioning. This setup enables the service provider to enforce security protocols across multiple organizations while giving each organization flexibility to tailor additional access policies specific to its organizational units and segmentation units. The platform 100 may further support various service provider types that offer predefined access control policies for different control levels, from full administrative access to minimal permissions. For example, a service provider may use these controls to create and manage tenants with varying levels of access and control. In some embodiments, a dedicated tenant type is created, allowing providers to control permissions, manage onboarding, and oversee data while ensuring compliance with platform-wide policies.

Each organization unit 130 may represent a client and may be the primary structure associated with each tenant on the platform 100. Each organization unit 130 may contain one or more segmentation units 140, which may further divide the organization to support data isolation, access control, and business segmentation. Each organization unit 130 may contain one or more segmentation units 140, which may further divide the organization to support data isolation, access control, and business segmentation. In some embodiments, each segmentation unit can operate independently, establishing its own access control policies, user groups, and data boundaries within the larger organizational structure. This independent configuration ensures that specific requirements, such as regional data governance, internal department isolation, or custom access rules, are maintained within each segmentation unit while still inheriting applicable high-level organizational policies. This setup also facilitates clear, hierarchical management, enabling granular control over user roles, permissions, and data resources at the segmentation level. In some embodiments, segmentation units 140 may be configured to support hierarchical structures, allowing each unit to have one or more child segmentation units. For example, a company might use segmentation units to represent different departments or regional branches within its organization, each with specific access policies and data boundaries. A segmentation unit 140 is a structural subdivision within an organization unit 130 that supports data isolation, access control, and business segmentation. Each segmentation unit 140 operates independently, allowing an organization to partition its resources, users, and assets according to specific business or security needs. Segmentation units can inherit policies from their parent organization unit, while still maintaining unique configurations for user groups and assets. Segmentation units 140 may also contain or be associated with user groups 150, allowing permissions to be managed at the group level, with actions attributed to user groups instead of individual users, thereby enhancing privacy and simplifying access control.

The platform 100 may include policies 190 that govern permissions, data access, and operational behavior across organizational units 130 and segmentation units 140. Policies are predefined rules that apply to data handling, security, compliance, and access within each tenant. For example, a data retention policy might ensure that records are retained for a minimum of five years, and a data access policy could limit certain files to specific departments. In some embodiments, policies 190 may be cascading, where high-level policies set by the organization unit apply automatically to segmentation units, but these policies can also be overridden at the segmentation unit level if needed to meet specific requirements. In some embodiments, cascading policies enable organization-level policies to apply automatically to all associated segmentation units, ensuring consistent security and operational standards across units. For example, a security policy requiring two-factor authentication (2FA) could be defined at the organization level and inherited by all segmentation units. However, administrators can override this inheritance for a specific segmentation unit if, for example, regional regulations necessitate alternative authentication methods. This override capability allows segmentation units to comply with unique requirements while maintaining broader organizational security protocols. In some embodiments, while policies can cascade from higher-level organizational units down to segmentation units to ensure consistent security and operational standards, the platform also supports selective policy overrides at specific segmentation unit levels. This flexibility allows segmentation units to customize certain policies dynamically, adapting to unique requirements such as regional regulatory demands or business-specific operational needs. For example, a global organization might enforce a two-factor authentication (2FA) requirement at the organizational level but allow segmentation units in certain regions to substitute with a local authentication standard as needed. This override capability helps maintain consistent, organization-wide policy standards while accommodating tenant-specific configurations in dynamic business environments.

The platform 100 facilitates asset sharing through an asset sharing model, where assets 180 are associated with specific segmentation units 140 and may be shared selectively with other units based on declarative protocols. Assets 180 may include data files, machine learning models, or applications essential for business operations. Declarative protocols specify access and sharing conditions through configuration-based rules, providing granular control over shared assets. In some embodiments, declarative protocols define access conditions based on factors such as user group attributes, operational roles, and time-based constraints. For example, access to financial reports may be limited to certain user groups during specific audit periods, or assets could be shared only between specific segmentation units under defined conditions. By setting these protocols in a configuration-based format, the platform enables consistent and secure access decisions, reducing the need for manual configurations and ensuring adaptable, rule-based access management across the platform. For example, access control lists (ACLs) may define which user groups or segmentation units can access specific assets, such as financial reports or project files. Declarative protocols within the platform are configuration-based rules that define standardized access and sharing conditions for assets 180 across segmentation units 140 and organizational units 130. By specifying access requirements through declarative protocols, the platform ensures consistency in asset interactions, facilitates tenant-specific customizations, and reduces manual configurations. These protocols enable granular access control through user groups 150, enhancing flexibility for cross-segmentation and cross-organization sharing. Additionally, the platform may include a catalog that gives visibility into available shared assets 180, allowing users to identify resources they have permission to access. The asset sharing model within the platform 100 provides a framework for controlled asset access and sharing across organizational and segmentation units. This model uses access control lists (ACLs) or equivalent authorization schemes associated with user groups 150 to specify permissions for shared assets 180, enabling tenants to selectively share resources while preserving security boundaries. By leveraging ACLs and declarative protocols, the asset sharing model supports flexible, governed asset access both within and between tenant organizations.

The execution context 160 is generated upon a tenant's request to access the platform 100. This runtime environment is specific to each tenant, encompassing the organizational unit 130, user group 150, and relevant policies 190 associated with the tenant. Designed to maintain tenant isolation while applying tenant-specific configurations, the execution context dynamically incorporates metadata elements—such as tenant identifiers, user group associations, and segmentation unit assignments—tailored to each tenant's unique needs. Execution context dynamically incorporates metadata elements—such as tenant identifiers, user group associations, and segmentation unit assignments—tailored to each tenant's unique needs. In some embodiments, the platform supports real-time evaluation of access permissions using Attribute-Based Access Control (ABAC). Permissions are dynamically granted or denied based on contextual attributes such as time, location, or device type at the moment of access. For example, a user may only access sensitive data during business hours from approved locations. All decisions are logged with the evaluated attributes to maintain compliance and traceability. This metadata provides the foundation for enforcing access controls and isolating data interactions, even within shared multi-tenant environments, keeping each tenant's data and operational boundaries intact. This metadata provides the foundation for enforcing access controls and isolating data interactions, even within shared multi-tenant environments, ensuring that each tenant's data and operational boundaries remain intact. For example, policies on access control, encryption protocols, and data-handling procedures are applied as defined by each tenant, enabling controlled access to resources and compliance with tenant-specific requirements. To support evolving needs, the execution context dynamically references tenant metadata to make real-time adjustments to policies and permissions. If a tenant's access requirements shift due to regulatory or business needs, the platform adapts configurations without manual intervention, aligning policies with current standards and reducing administrative overhead. Additionally, this adaptability is enhanced by real-time metadata updates reflecting changes in tenant-specific access requirements, user groups, or segmentation units. For instance, adjustments to security protocols or user group permissions are automatically synchronized within the execution context. This capacity for real-time adaptation ensures that configurations remain consistent with each tenant's needs, supporting security, compliance, and operational flexibility. In some embodiments, the execution context 160 can also adjust the platform's operating mode between shared multi-tenant and isolated single-tenant settings based on tenant isolation requirements. By default, non-sensitive services may operate in multi-tenant mode to optimize resource use, while tenants with heightened data privacy needs may utilize isolated single-tenant instances. This flexible approach allows the platform to serve diverse tenant requirements, balancing data privacy with efficient resource allocation.

As shown in FIG. 1, users 170 are organized within user groups 150 under segmentation units 140 and may access assets 180 based on permissions scoped to their user group, segmentation unit, and applicable policies 190. This hierarchical structure of user groups, segmentation units, and policies 190 supports large-scale client management while maintaining security, resource efficiency, and data isolation across the platform 100. Data organization within platform 100 is tenant-aware, allowing logical and physical data isolation based on policies defined at the segmentation unit level. This isolation ensures that data ownership, resource allocation, and usage tracking are clearly separated across tenants. A repository may provide visibility into shared assets across the platform ecosystem, enabling assets to be discoverable via search and recommendation features. Analytics features may also provide insights into asset usage patterns and popularity, supporting asset providers in resource management and informed decision-making. User groups 150 within segmentation units 140 act as primary vehicles for access control and policy enforcement. Each user group is associated with specific segmentation units 140 and assets 180 within that segmentation unit. This structure enables fine-grained control over resource access and operational permissions, allowing segmentation units to manage user permissions in alignment with both tenant-wide policies and specific access needs. In some embodiments, user groups can be assigned unique roles and permissions based on their segmentation unit's hierarchical level, offering further isolation or shared access as required.

### Policies

Policies 190 may include access control policies, data security policies, multi-tenancy policies, compliance and audit policies, and management policies, each of which can be defined at various levels within the organization, such as segmentation units 140. The platform 100 allows policies to be inherited from parent segmentation units or customized by administrators at each unit. The platform 100 allows policies to be inherited from parent segmentation units or customized by administrators at each unit. In cases where policies are inherited, administrators at segmentation units can choose to either apply the inherited policies as-is or override them with more specific policies to meet unique operational requirements. This flexibility supports diverse policy needs across segmentation levels while preserving a consistent framework for data protection and compliance. For example, while an organization-wide data encryption policy may be set at the top level, a segmentation unit handling sensitive financial information could enforce additional restrictions, such as stricter access controls or enhanced audit logging. This structure enables organizations to establish uniform policies while allowing flexibility for specialized needs across different segmentation units. In some embodiments, access control policies define the permissions and conditions under which user groups 150 may access assets 180. Examples include asset access policies, where specific user groups 150 may view customer-related assets 180 within their segmentation unit 140, and user group access policies, which allow certain groups, such as marketing teams, to access assets specific to their needs, such as promotional materials. Management access policies may allow user groups 150 to manage memberships within their segmentation units 140, while time-based access policies restrict access windows for sensitive assets 180. Two-factor authentication policies may be applied to secure high-sensitivity assets, and location-based access policies restrict asset access based on physical location or IP range. In some embodiments, role-based access control policies may assign roles such as admin, user, or viewer to user groups 150, granting access based on role permissions, while attribute-based access control policies further refine access based on defined attributes. Emergency access policies may outline conditions and procedures for granting temporary access to critical assets under specific circumstances. The execution context 160 applies these policies 190 in a way that aligns with each tenant's unique configuration. In some embodiments, the execution context is generated dynamically with metadata that reflects the policies associated with specific organizational and segmentation units. For example, a segmentation unit's data security policies may enforce encryption requirements across all assets accessed through the execution context, ensuring that tenant-specific policies persist even in shared multi-tenant mode.

Data security policies may enforce security measures on assets 180 to protect sensitive information and maintain compliance. Examples include data encryption policies, which may require assets with financial data to use encryption such as AES-256, and data retention policies, which dictate retention periods for records like customer support logs. Data classification policies label assets for access restrictions based on sensitivity, and data masking policies mask sensitive information within records to limit exposure. Data loss prevention policies may prevent transfer of restricted information, such as credit card numbers, outside the organization's network, while data sanitization policies may ensure sensitive data is removed before archiving. Secure disposal policies may mandate that assets are deleted securely at the end of their lifecycle, and access expiry policies provide temporary access to vendors, which expires automatically at the end of a defined period.

Multi-tenancy policies may manage data isolation, access, and resource limitations across different tenants. A tenant isolation policy may ensure physical separation of tenant assets, while cross-tenant access policies allow user groups in one tenant, such as research teams, to request read-only access to assets in another tenant. Resource quota policies define limits on storage or computing resources per tenant to prevent overuse, and tenant onboarding policies may define steps for adding new tenants, including security checks. Off-boarding policies may detail the steps to follow when a tenant leaves, including data retention and handover requirements. Data segregation policies ensure that tenant data remains logically separate within shared databases, while tenant communication policies establish secure collaboration protocols for tenants.

Compliance and audit policies ensure that the platform 100 adheres to industry regulations and provides traceability for access and changes. Access logging policies may log all access attempts to sensitive data, such as financial records, while compliance policies ensure assets containing personal data meet GDPR standards. Regulatory compliance policies may define the standards an organization must follow, such as GDPR or HIPAA, while risk assessment policies require regular evaluation of security and compliance risks. Penetration testing policies may mandate regular security testing, and incident response policies may establish a response framework for security incidents. Audit trail policies track changes to sensitive data, access review policies ensure permissions are regularly reviewed, and audit retention policies specify the retention period for audit logs. Audit log integrity policies prevent tampering with logs, and user activity monitoring policies detect unusual behavior to prevent security breaches.

Management policies oversee the administration of resources, access, and policies within segmentation units 140 and across the organization. Hierarchical policy assignment allows segmentation unit managers to define policies specific to their units, while policy inheritance allows sub-segmentation units to inherit policies from parent units. Change management policies may outline the procedures for policy, permission, and configuration changes, and resource allocation policies define resource distribution based on segmentation unit needs. Backup and restore policies may establish schedules and processes for data recovery, while version control policies help prevent accidental data loss by tracking asset changes. User provisioning and de-provisioning policies may define onboarding and off-boarding processes for users, ensuring proper access control throughout their lifecycle in compliance with privacy and security standards. This structure demonstrates how the user group tenancy model enables access control to assets across segmentation units within an organization by using customizable policies that adapt to organizational and regulatory needs.

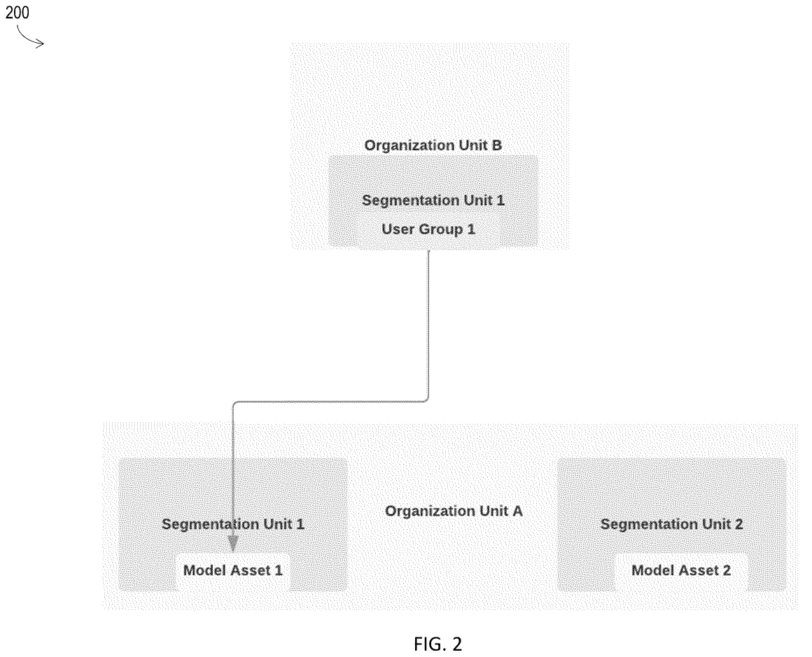

FIG. 2 is a diagram illustrating an example of the asset sharing model 200 by the multi-tenant platform, in accordance with one or more embodiments. As shown in FIG. 2, an example of asset sharing is illustrated between organization units and segmentation units across different organization units on the platform. In this scenario, organization unit A includes two segmentation units: segmentation unit 1, which owns model asset 1, and segmentation unit 2, which owns model asset 2. Organization unit B has one segmentation unit, segmentation unit 1, which creates user group 1 specifically to access model asset 1 owned by organization unit A's segmentation unit 1. User group 1 is granted access to model asset 1 across organization units, enabling controlled access to assets between organization units and segmentation units on the platform. In this model, user groups may act as the sharing contract vehicle, managing permissions and access conditions for assets across organizational boundaries. This structure allows assets to be securely shared between organization units and segmentation units in a controlled and managed manner through user groups, while the provider organization retains full oversight and control over all sharing activities. In some embodiments, instead of extending existing user groups for cross-organization access, the platform may require creating new users in the identity provider (IDP) specific to the external organization. These newly created users can then be associated with dedicated user groups that are granted permissions to access shared assets across organization units. This approach may enhance security by enabling access being limited to verified external users and provides a clear audit trail for compliance purposes. For example, when organization unit A shares model asset 1 with an external organization unit B, the system prompts the creation of new users within the external organization's IDP, which are then added to a new user group explicitly configured for this access scenario. This enables that cross-organization access adheres to strict security protocols while maintaining tenant isolation.

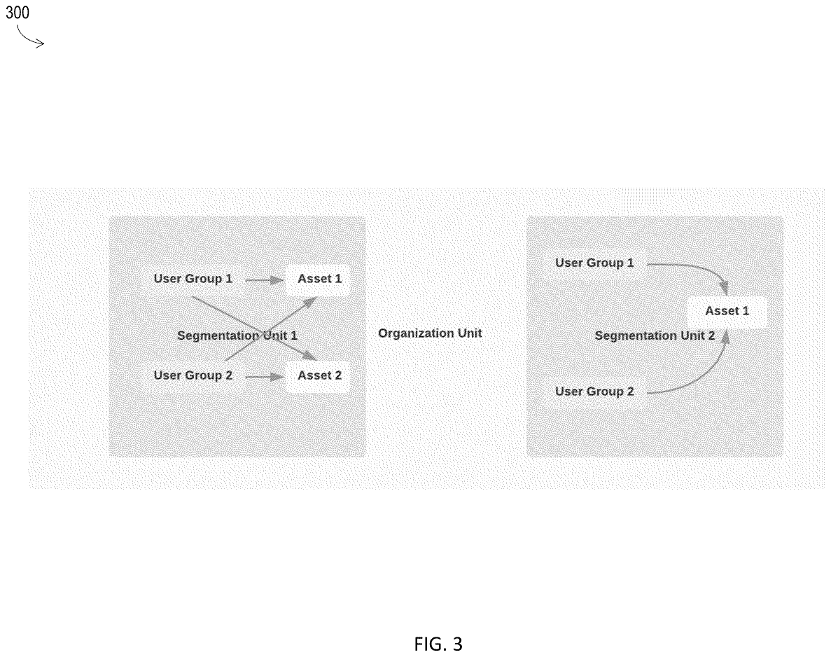

FIG. 3 is a diagram illustrating an example of the user group tenancy model 300 to illustrate asset control flow within the multi-tenant platform, in accordance with one or more embodiments. As shown in FIG. 3, the user group tenancy model on the platform allows clients to control access at the user group level, rather than the individual user level, enhancing privacy, simplifying management, and ensuring granular permissions within each organization.

Each organization may be composed of multiple segmentation units that serve as sub-divisions within the organization, such as departments or project teams. Each segmentation unit may contain several user groups, which are collections of users defined and managed by the client's or service provider's identity provider (IDP). In this model, user groups act as the primary vehicle for access control. Permissions are assigned at the user group level, not the individual user level, meaning that each user group has access only to assets within its designated segmentation unit. This model enables clients to manage their own users and user groups independently, without the platform handling individual user information, thereby protecting user privacy.

In FIG. 3, users are assigned to specific user groups, and each user group may be associated with to one or more segmentation units. As shown in FIG. 2, user group 1 and user group 2 may be both associated to segmentation unit 1. In some embodiments, user group 1 and user group 2 may be also associated to segmentation unit 2. In some embodiments, as shown in FIG. 3, user group 1 may have permission to access both asset 1 and asset 2. In an alternative embodiment, when under the management of segmentation unit 2, the user group 1 may only have permission to access asset 1.

An asset can be shared across segmentation units within an organization, or it can also be shared across organization units and across the segmentation units within that organization unit. In some embodiments, tenant administrators for the segmentation unit may explicitly authorize user groups associated with different segmentation units permissions to share the assets. The platform implements a security and authorization model that combines multiple layers of access control to enable secure asset sharing while maintaining privacy and flexibility. In some embodiments, the platform uses Role-Based Access Control (RBAC) and/or Attribute-Based Access Control (ABAC) with Access-Control lists (ACLs) to make decisions about who can access what resources and under what conditions. Utilizing the user group tenancy model, where all permissions are managed through user groups rather than individual users, this platform is able to provide granular access control, enhance privacy, and simplify permission management across complex organizational structures. This approach is particularly powerful because it allows users to belong to multiple groups simultaneously. Access to assets is primarily controlled through segmentation units, which act as security boundaries within organizations. In some embodiments, assets live within these units, and in some instances, only user groups within the same unit can access these assets. Alternatively or additionally, the platform recognizes that modern organizations need flexibility, so it provides mechanisms for cross-segmentation access through specially created user groups that can be added to an asset's Access Control List (ACL). When it comes to sharing across different organizations, the platform takes additional security precautions. Rather than simply adding external user groups to an ACL, in some of the use cases, the platform requires creating new users in the identity provider (IDP). This extra step ensures proper security measures are maintained and creates a clear audit trail of who has access to what. The Identity and Access Management Service manages the ACLs and verifying permissions in real-time. Every time someone attempts to access an asset, the service may check multiple factors: the user's group memberships, their role-based permissions, and any attribute-based conditions that might apply (such as time of day or location). To maintain accountability without compromising privacy, the platform logs all actions and attributes them to user groups rather than individual users. This creates a detailed audit trail that organizations can use for compliance and security monitoring while protecting individual privacy. This system is able to handle different access scenarios effective and flexibility. For example, organizations can create temporary access arrangements, implement time-bound permissions, or establish cross-functional access patterns as needed. At the same time, they maintain strict control through the ability to restrict or revoke access immediately when required. This balance between flexibility and security makes the platform suitable for complex enterprise environments where both collaboration and data protection are crucial. The system supports dynamic organizational needs while ensuring that all access remains controlled, monitored, and auditable. FIG. 3 demonstrates that the user group tenancy model enables granular, secure access control within an organization's segmentation units, while maintaining user privacy. User groups serve as the secure access control mechanism, granting permissions at the group level and enabling precise tracking and attribution of usage across the platform.

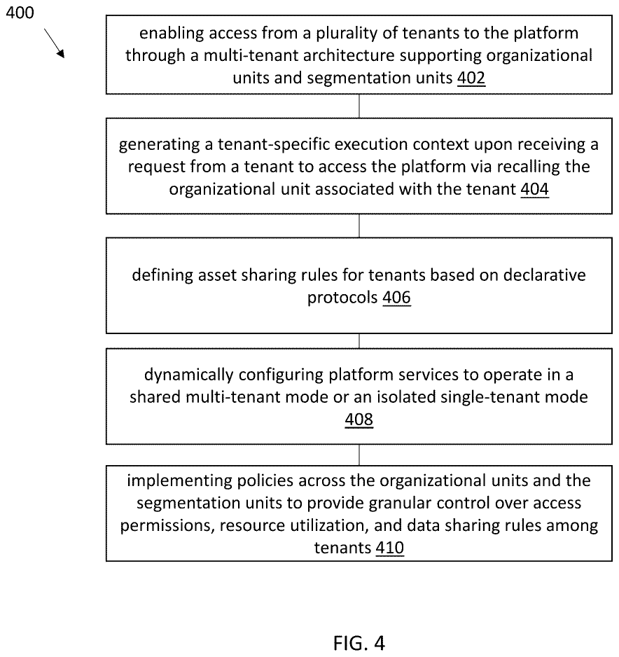

FIG. 4 is a diagram illustrating a flow chart of a process 400 for managing a multi-tenant platform, in accordance with one or more embodiments of the current subject matter. As shown in FIG. 4, the process 400 may begin with operation 402, where the system enables access from a plurality of tenants to the platform through a multi-tenant architecture, which supports organizational units and segmentation units. Each tenant may be associated with an organization unit and one or more segmentation units, providing a structure for resource allocation and permission boundaries within each tenant. In operation 404, the system generates a tenant-specific execution context upon receiving a request from a tenant to access the platform. This execution context may include metadata configured to maintain tenant isolation and propagate tenant-specific configurations and access controls on the platform for the tenant. In some embodiments, the execution context may be generated via recalling the organizational unit associated with the tenant, wherein the execution context includes metadata configured to maintain tenant isolation and propagate tenant-specific configuration and access controls on the platform for the tenant. In some embodiments, the execution context is configured dynamically based on the tenant's predefined requirements, such as ensuring data isolation within shared services or enabling access to specialized resources within the platform.

The process continues with operation 406, where the system defines asset sharing rules for tenants based on declarative protocols. The asset sharing rules may allow selective and controlled access to shared assets between tenants, and the declarative protocols may specify conditions for asset access and sharing in a configuration-based format. For example, in some embodiments, the asset sharing model allows granular control over asset accessibility by defining which user groups or segmentation units are granted access to specific assets, depending on factors such as organizational boundaries, user roles, or security requirements. In operation 408, the system dynamically configures platform services to operate in either a shared multi-tenant mode or an isolated single-tenant mode, according to the tenant-specific requirements for data isolation defined in the execution context. In some embodiments, non-sensitive services may default to multi-tenant mode for optimal resource usage, while tenants with enhanced security needs may be selectively transitioned to single-tenant mode for isolated access, ensuring flexibility in data handling and platform operation. Single-tenant mode and shared multi-tenant mode are two configurations within a multi-tenant platform that cater to varying levels of data isolation and resource sharing needs. In single-tenant mode, a tenant operates within a dedicated instance of a service, ensuring complete isolation from other tenants—ideal for clients with strict privacy, regulatory, or security requirements. This mode prevents data mingling and provides full control over data and resources, albeit with a higher resource demand. In contrast, shared multi-tenant mode allows multiple tenants to share a single instance of a service, optimizing resource usage and reducing costs. This mode is suitable for tenants with lower isolation needs and emphasizes efficiency, enabling the platform to serve multiple clients from a common infrastructure while maintaining general security standards.

In some embodiments, the system's capability to dynamically configure platform services to operate in either a shared multi-tenant mode or an isolated single-tenant mode enables resource adjustments based on each tenant's unique requirements. This flexibility accommodates tenants with diverse data isolation needs: some tenants may require rigorous data privacy and regulatory compliance, while others may benefit from cost-effective, shared resources. Upon receiving a tenant access request, a configuration module assesses the tenant's execution context, which includes data isolation requirements, security policies, and data sensitivity, and configures the services accordingly. For tenants with high data isolation needs, the platform allocates dedicated, single-tenant instances, ensuring complete data segregation and compliance with privacy standards. For tenants with high data isolation needs, the platform allocates dedicated, single-tenant instances, ensuring complete data segregation and compliance with privacy standards. In these instances, tenant-specific configurations are strictly applied to isolate both data and operations, including exclusive access to backend resources, database partitions, and computation nodes. This setup minimizes the risk of cross-tenant data exposure by creating isolated environments tailored to each tenant's privacy and compliance requirements. Conversely, tenants with lower isolation needs are directed to shared instances where resources are pooled but still managed securely to maintain data integrity. Tenants with lower isolation needs may be directed to shared instances, enhancing efficiency and reducing operational costs. This adaptive configuration approach allows the platform to offer a customized environment that balances privacy requirements with optimal resource utilization for each tenant. In some embodiments, the platform includes a dynamic configuration module that reviews the execution context metadata associated with each tenant. This module assesses data isolation requirements, security preferences, and resource utilization policies to select an appropriate tenancy mode. For example, non-sensitive services are configured in shared multi-tenant mode by default to optimize resource use, but sensitive operations—such as those involving financial data—are assigned dedicated, isolated resources. This dynamic adjustment ensures each tenant's isolation requirements are respected, adapting platform operation based on real-time contextual assessments.

For example, in some embodiments, the platform 100 includes a dynamic configuration module that evaluates each tenant's data isolation needs from its execution context. For example, Tenant A, a financial services firm subject to strict data privacy laws, has high data sensitivity requirements noted in its execution context. When Tenant A requests access to platform services, the configuration module assigns isolated single-tenant resources to Tenant A, ensuring exclusive access to services like data storage and analytics processing, preventing data from mingling with other tenants. In contrast, Tenant B, a market research company dealing with publicly accessible data, does not need such strict isolation. Based on Tenant B's execution context, the configuration module assigns shared, multi-tenant resources for Tenant B's operations, allowing efficient resource use and cost savings. If Tenant A's isolation needs change temporarily, the platform can dynamically reconfigure certain services to allow shared access, thus creating a hybrid mode with both shared and isolated resources based on real-time assessments. This flexibility allows the platform to meet diverse client needs for privacy, compliance, and efficiency in a scalable way.

In operation 410, the system implements policies across the organizational units and segmentation units, allowing granular control over access permissions, resource utilization, and data sharing rules among tenants. The policies may be defined to cascade from higher-level organizational units to segmentation units within each tenant, thereby allowing an efficient inheritance mechanism. In some embodiments, these policies can be overridden at the segmentation unit level to meet specific organizational needs or compliance requirements, allowing tenants to tailor access control and compliance rules within the constraints of the multi-tenant platform. In some embodiments, these policies can be overridden at the segmentation unit level to meet specific organizational needs or compliance requirements, allowing tenants to tailor access control and compliance rules within the constraints of the multi-tenant platform. In cases where segmentation units apply policy overrides, these exceptions are carefully tracked and logged to ensure alignment with overarching organizational guidelines. For example, an override for regional compliance in one segmentation unit may require specific logging or reporting obligations, ensuring transparency and traceability across the platform's multi-tenant structure. This approach provides flexibility for unit-specific requirements while maintaining visibility and adherence to broader organizational policies. The process may also involve logging and monitoring actions within the platform to attribute usage and activities to specific user groups associated with each tenant. This attribution enhances traceability and auditability while maintaining user privacy by associating actions with user groups rather than individual users. In some embodiments, the system may provide an interactive user interface where administrators can visualize and manage access policies, asset sharing configurations, and execution contexts, allowing them to adjust based on usage patterns or organizational changes.

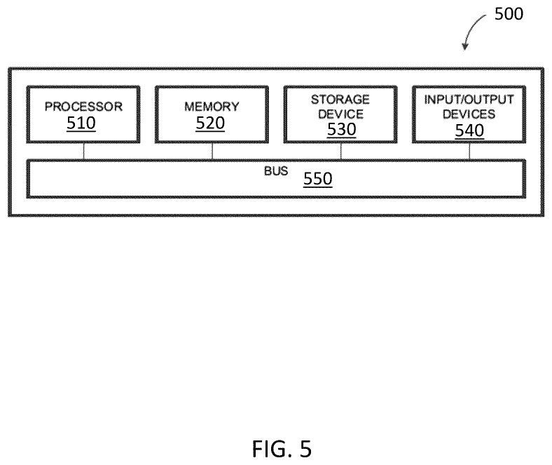

FIG. 5 depicts a block diagram illustrating a computing system 500 consistent with implementations of the current subject matter. As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer-readable medium, such as volatile or non-volatile memory, that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for managing a multi-tenant platform, comprising:
enabling access from a plurality of tenants to the platform through a multi-tenant architecture supporting organizational units and segmentation units, wherein each of the plurality of tenants is associated with an organization unit and one or more segmentation unit;
generating a tenant-specific execution context upon receiving a request from a tenant to access the platform via recalling the organizational unit associated with the tenant, wherein the execution context includes metadata configured to maintain tenant isolation and propagate tenant-specific configuration and access controls on the platform for the tenant;
defining asset sharing rules for tenants based on declarative protocols, wherein the asset sharing rules allow selective and controlled access to shared assets between tenants, and wherein the declarative protocols are configuration-based rules that specify conditions for asset access and sharing;
dynamically configuring platform services to operate in a shared multi-tenant mode or an isolated single-tenant mode, according to tenant-specific requirements for data isolation in the execution context; and
implementing policies across the organizational units and the segmentation units to provide granular control over access permissions, resource utilization, and data sharing rules among tenants.

2. The method of claim 1, wherein the policies are cascading policies where policies associated with an organization unit for a particular tenant apply to the one or more segmentation units of the particular tenant.

3. The method of claim 2, wherein the policies are overridable at the one or more segmentation units.

4. The method of claim 1, wherein each of the plurality of tenants comprises one or more users, the method further comprises assigning the one or more users to user groups, wherein each user group is associated with permissions that are scoped to designated assets, segmentation units, and applicable policies.

5. The method of claim 4, wherein the execution context comprises a tenant identifier and user group information associated with the tenant.

6. The method of claim 5, wherein the execution context provides a tenant-specific runtime environment to isolate operations and enforce policies when a tenant accesses the platform.

7. The method of claim 6, further comprising monitoring and logging a plurality of actions performed within the execution context, wherein each action of the plurality of actions is attributed to a specific user group and segmentation unit of the tenant to provide traceability.

8. A computer program product, for managing a multi-tenant platform, comprising a non-transient machine-readable medium storing instructions that, when executed by at least one programmable processor, cause the at least one programmable processor to perform operations comprising:
enabling access from a plurality of tenants to the platform through a multi-tenant architecture supporting organizational units and segmentation units, wherein each of the plurality of tenants is associated with an organization unit and one or more segmentation unit;
generating a tenant-specific execution context upon receiving a request from a tenant to access the platform via recalling the organizational unit associated with the tenant, wherein the execution context includes metadata configured to maintain tenant isolation and propagate tenant-specific configuration and access controls on the platform for the tenant;
defining asset sharing rules for tenants based on declarative protocols, wherein the asset sharing rules allow selective and controlled access to shared assets between tenants, and wherein the declarative protocols are configuration-based rules that specify conditions for asset access and sharing;
dynamically configuring platform services to operate in a shared multi-tenant mode or an isolated single-tenant mode, according to tenant-specific requirements for data isolation in the execution context; and
implementing policies across the organizational units and the segmentation units to provide granular control over access permissions, resource utilization, and data sharing rules among tenants.

9. The computer program product of claim 8, wherein the policies are cascading policies where policies associated with an organization unit for a particular tenant apply to the one or more segmentation units of the particular tenant.

10. The computer program product of claim 9, wherein the policies are overridable at the one or more segmentation units.

11. The computer program product of claim 8, wherein each of the plurality of tenants comprises one or more users, the operations further comprise assigning the one or more users to user groups, wherein each user group is associated with permissions that are scoped to designated assets, segmentation units, and applicable policies.

12. The computer program product of claim 11, wherein the execution context comprises a tenant identifier and user group information associated with the tenant.

13. The computer program product of claim 12, wherein the execution context provides a tenant-specific runtime environment to isolate operations and enforce policies when a tenant accesses the platform.

14. The computer program product of claim 13, the operations further comprises monitoring and logging a plurality of actions performed within the execution context, wherein each action of the plurality of actions is attributed to a specific user group and segmentation unit of the tenant to provide traceability.

15. A system, for managing a multi-tenant platform, comprising:
at least one programmable processor; and
a non-transient machine-readable medium storing instructions that, when executed by the processor, cause the at least one programmable processor to perform operations comprising:
enabling access from a plurality of tenants to the platform through a multi-tenant architecture supporting organizational units and segmentation units, wherein each of the plurality of tenants is associated with an organization unit and one or more segmentation unit;
generating a tenant-specific execution context upon receiving a request from a tenant to access the platform via recalling the organizational unit associated with the tenant, wherein the execution context includes metadata configured to maintain tenant isolation and propagate tenant-specific configuration and access controls on the platform for the tenant;
defining asset sharing rules for tenants based on declarative protocols, wherein the asset sharing rules allow selective and controlled access to shared assets between tenants, and wherein the declarative protocols are configuration-based rules that specify conditions for asset access and sharing;
dynamically configuring platform services to operate in a shared multi-tenant mode or an isolated single-tenant mode, according to tenant-specific requirements for data isolation in the execution context; and
implementing policies across the organizational units and the segmentation units to provide granular control over access permissions, resource utilization, and data sharing rules among tenants.

16. The system of claim 15, wherein the policies are cascading policies where policies associated with an organization unit for a particular tenant apply to the one or more segmentation units of the particular tenant.

17. The system of claim 16, wherein the policies are overridable at the one or more segmentation units.

18. The system of claim 15, wherein each of the plurality of tenants comprises one or more users, the operations further comprise assigning the one or more users to user groups, wherein each user group is associated with permissions that are scoped to designated assets, segmentation units, and applicable policies.

19. The system of claim 18, wherein the execution context comprises a tenant identifier and user group information associated with the tenant.

20. The system of claim 19, wherein the execution context provides a tenant-specific runtime environment to isolate operations and enforce policies when a tenant accesses the platform.
